(19) United States
(12) Patent Application Publication
(10) Pub. No.: US 2023/0315482 A1
(43) Pub. Date: Oct. 5, 2023

(54) MICROCONTROLLER AND UPDATE METHOD FOR MICROCONTROLLER

(71) Applicant: LAPIS Technology Co., Ltd., Yokohama (JP)

(72) Inventor: Kenichi MORIOKA, Yokohama (JP)

(73) Assignee: LAPIS Technology Co., Ltd., Yokohama (JP)

(21) Appl. No.: 18/186,377

(22) Filed: Mar. 20, 2023

(30) Foreign Application Priority Data
Mar. 30, 2022 (JP) 2022-057276

(51) Int. Cl. G06F 9/4401; G06F 12/0891

(52) U.S. Cl. CPC G06F 9/4403; G06F 12/0891; G06F 2212/251

(57) ABSTRACT

A microcontroller unit (MCU) includes a central processing unit (CPU) that reads a program from a flash read-only memory (ROM) and executes a process, a remapping register that stores a read destination of the flash ROM to be read by the CPU, an overwrite flag register that stores a flag that determines whether or not to overwrite the program stored in the flash ROM when the CPU is reset, and a dedicated remapping reset register that resets the CPU and the remapping register but does not reset the overwrite flag register when a value indicating resetting of the CPU and the remapping register is written thereto.

### CROSS REFERENCE TO RELATED APPLICATION

This application is based upon and claims the benefit of priority of the prior Japanese Patent Application No. 2022-057276, filed on Mar. 30, 2022, the entire contents of which are incorporated herein by reference.

### TECHNICAL FIELD

The present invention relates to a microcontroller and an update method for a microcontroller.

### BACKGROUND ART

Microcontroller units (also referred to below as “MCUs”) start execution of instructions starting with address 0 in a memory space when executing programs. Conventionally, there have been MCUs that use an area where the address 0 exists in the memory space (referred to here as bank0) as a remappable space, and that execute programs while remapping programs to be executed to bank0 as needed.

Japanese Patent Application Laid-Open Publication No. 2012-141667 discloses an interruption control device that can ensure immediate execution of an interruption process in a processor where a plurality of interruption requests share one interruption vector without modifying the processor itself and even if the interruption vector address is stored in a non-writable area.

### SUMMARY OF THE INVENTION

In updating a program stored in a memory, storing an update program for updating the program in the same memory results in a reduction in usable capacity of the memory.

The present invention takes into consideration this problem, and an object thereof is to provide a microcontroller and an update method for a microcontroller by which it is possible to mitigate a reduction in the usable capacity of a memory, while enabling updating of programs stored in the memory.

One aspect of the present invention provides a microcontroller, including: a memory unit; a processor that reads a program stored in the memory unit from the memory unit and executes a process; a remapping information storage area that stores an address that designates an area to be remapped by the processor; an overwrite flag storage area that stores a flag that determines whether or not to overwrite the program stored in the memory unit; and a reset information storage area to store information for resetting the processor and the remapping information storage area when information indicating resetting of the processor and the remapping information storage area is written to the reset information storage area.

Another aspect of the present invention provides an update method for a microcontroller including: a reset information writing step of writing, to a reset information storage area, information indicating resetting of a processor that executes a process by reading a program stored in a memory unit from the memory unit, and a remapping information storage area that stores an address that designates an area to be remapped by the processor; and a dedicated remapping reset step of resetting the processor and the remapping information storage area based on the information written to the reset information storage area.

According to the present invention, it is possible to provide a microcontroller and an update method for a microcontroller by which it is possible to mitigate a reduction in the usable capacity of a memory, while enabling updating of programs stored in the memory.

### BRIEF DESCRIPTION OF THE DRAWINGS

FIG. 1 is a drawing for describing one example of remapping of a flash ROM in an MCU.

FIG. 2 is a drawing for describing one example of remapping of a flash ROM in an MCU.

FIG. 3 is a drawing for describing one example of remapping of a flash ROM in an MCU.

FIG. 4 is a drawing for describing one example of an overwriting flow for a user program stored in a flash ROM of an MCU.

FIG. 5 is a drawing for describing one example of an overwriting flow for a user program stored in a flash ROM of an MCU.

FIG. 6 is a drawing for describing one example of an overwriting flow for a user program stored in a flash ROM of an MCU.

FIG. 7 is a drawing for describing one example of an overwriting flow for a user program stored in a flash ROM of an MCU.

FIG. 8 is a drawing for describing one example of an overwriting flow for a user program stored in a flash ROM of an MCU.

FIG. 9 is a drawing for describing one example of an overwriting flow for a user program stored in a flash ROM of an MCU.

FIG. 10 is a drawing for describing one example of an overwriting flow for a user program stored in a flash ROM of an MCU.

FIG. 11 shows a configuration example of an MCU according to an embodiment of the present invention.

FIG. 12 is a flowchart showing an example of a reset process flow of the MCU according to the embodiment.

FIG. 13 is a drawing for describing one example of an overwriting flow for a user program stored in a flash ROM of the MCU according to the embodiment.

FIG. 14 is a drawing for describing one example of an overwriting flow for a user program stored in a flash ROM of the MCU according to the embodiment.

### DETAILED DESCRIPTION OF EMBODIMENTS

Examples of embodiments of the present invention will be explained below with reference to the drawings. The same or equivalent components and portions in the drawings are assigned the same reference characters. The dimensional ratios in the drawings are exaggerated for ease of description, and in some cases differ from the actual ratios.

### Comparison Example

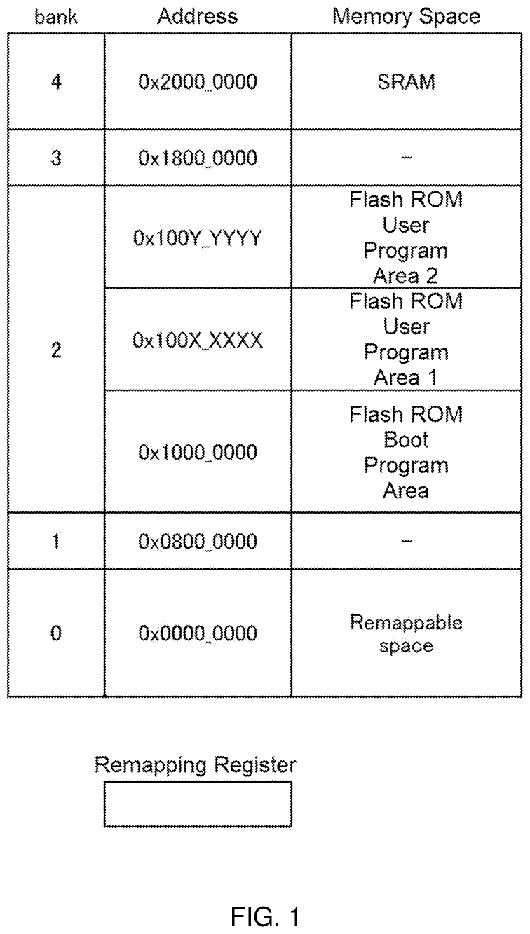

Before describing in detail an example of an embodiment of the present invention, a comparison example of the embodiment of the present invention will be described below. FIGS. 1 to 3 are drawings for describing examples of remapping of a flash ROM in an MCU. FIGS. 1 to 3 show addresses and memory spaces corresponding to “bank,” which indicates the subdivisions of the memory space. bank0 is a remappable space in the memory space, and an area starting with the address designated by the remapping register is remapped thereto. bank1 and bank3 are reserved areas in the memory space where writing is performed thereafter. bank2 is an area where programs in the memory space are stored, and specifically, is an area where programs in a flash read-only memory (ROM) are stored. bank4 is an area where programs in the memory space are stored, and specifically, is a static random access memory (SRAM) area where programs in an SRAM are stored. In examples shown in FIG. 1 and subsequent drawings, bank2 is constituted of a flash ROM boot program area where a boot program of the flash ROM is stored, a flash ROM user program area 1 where a user program 1 of the flash ROM is stored, and a flash ROM user program area 2 where a user program 2 of the flash ROM is stored. Here, the central processing unit (CPU) executes programs in the memory space in the order of bank0, bank1, bank2, etc.

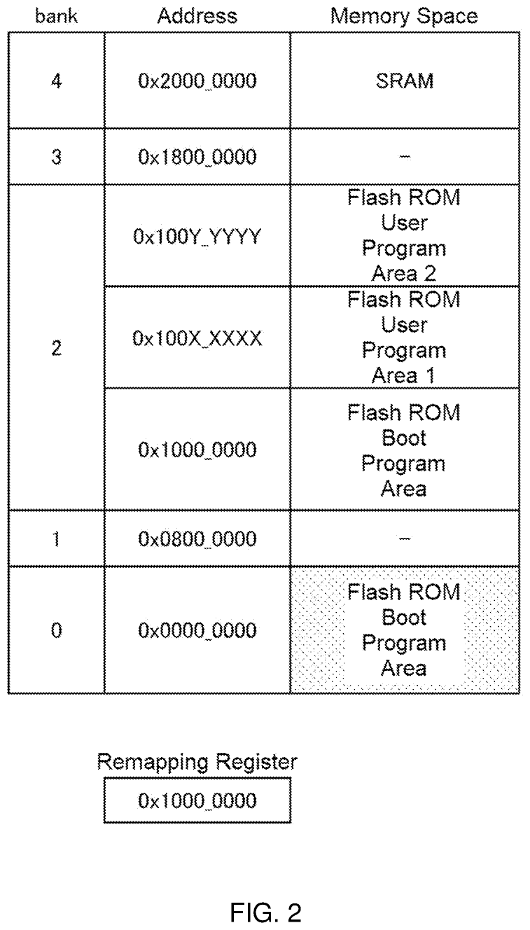

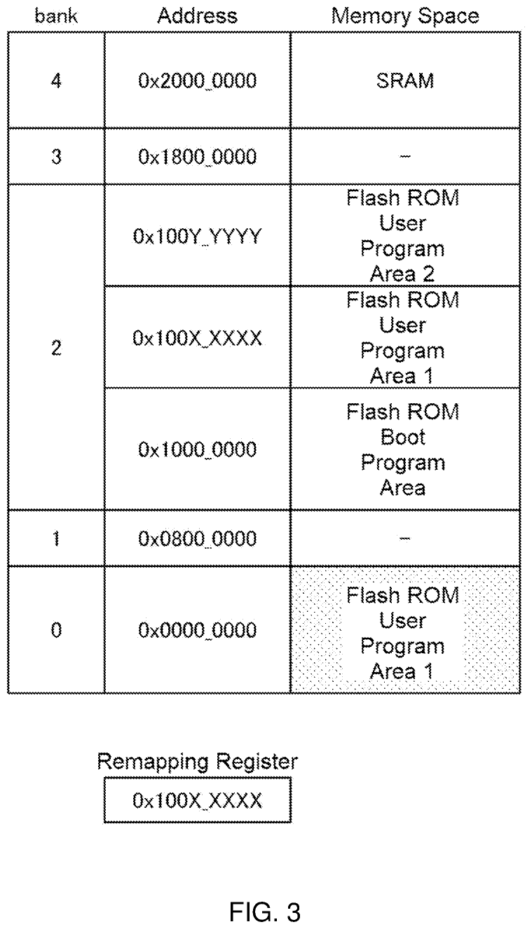

As shown in FIG. 2, when turning on the power source, the flash ROM boot program area of bank2 is remapped to bank0, and processes up to starting up a user program are executed. As shown in FIG. 3, when the CPU executes the user program 1, the flash ROM user program area 1 of bank2 is remapped to bank0, and the user program 1 is executed. Remapping is processed by writing the beginning address of a to-be-remapped area to a remapping register. When remapping the user program 1 of bank2 to bank0, for example, the address 0x100X_XXXX where the user program 1 is written to the remapping register. The remapping process is effective as of when the address is written for the remapping register. As shown in FIG. 3, when the address 0x100X_XXXX is written to the remapping register, the flash ROM user program area 1 to be executed by the CPU is remapped to bank0, and the user program 1 is executed.

In the MCU, there are cases in which it is necessary to overwrite a user program stored in the flash ROM for the purpose of updating functions or the like. Below, examples are described of a case in which a user program stored in the flash ROM is overwritten.

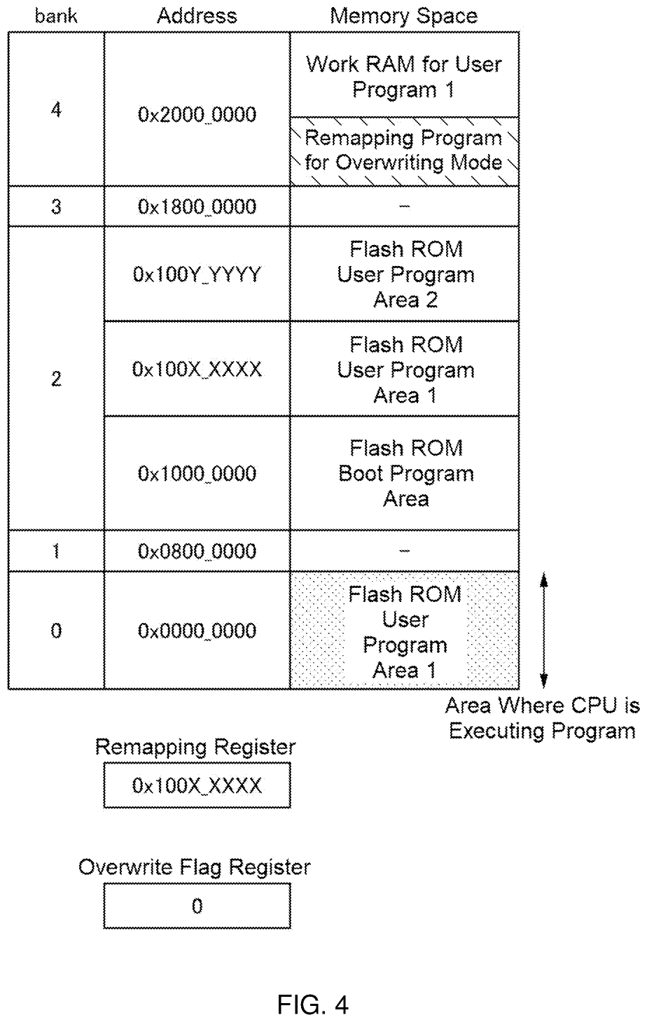

FIGS. 4 to 10 are drawings for describing examples of an overwriting flow for a user program stored in a flash ROM of an MCU. Similarly to FIG. 1, FIGS. 4 to 10 show addresses and memory spaces corresponding to “bank,” which indicates the subdivisions of the memory space. In order to overwrite the user program stored in the flash ROM, the SRAM area of bank4 stores a remapping program for an overwriting mode.

FIG. 4 shows a state in which the user program 1 in bank2, which was remapped to bank0, is in operation. When the user program 1 is being executed, the SRAM area of bank4 is typically used as the working memory for the program, but a portion thereof is used to store the remapping program for overwriting mode in order to update a program described below. That is, the SRAM area of bank4 is constituted of a work RAM area for the user program 1 for operating the user program 1, and an overwriting mode remapping program for updating the program.

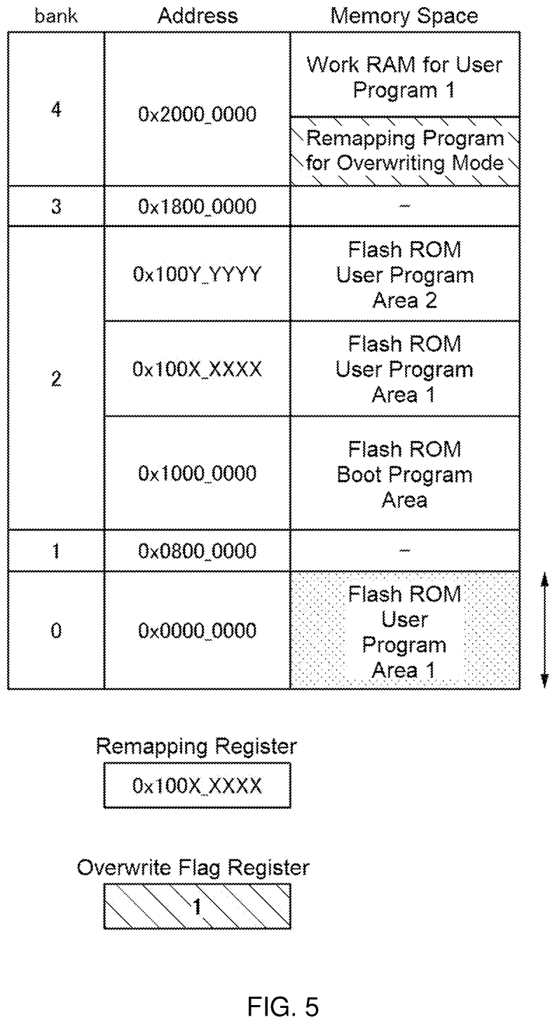

In the state shown in FIG. 4, if there is an update request for a program from outside the MCU, the flag of an overwrite flag register shown in FIG. 5 is set to 1.

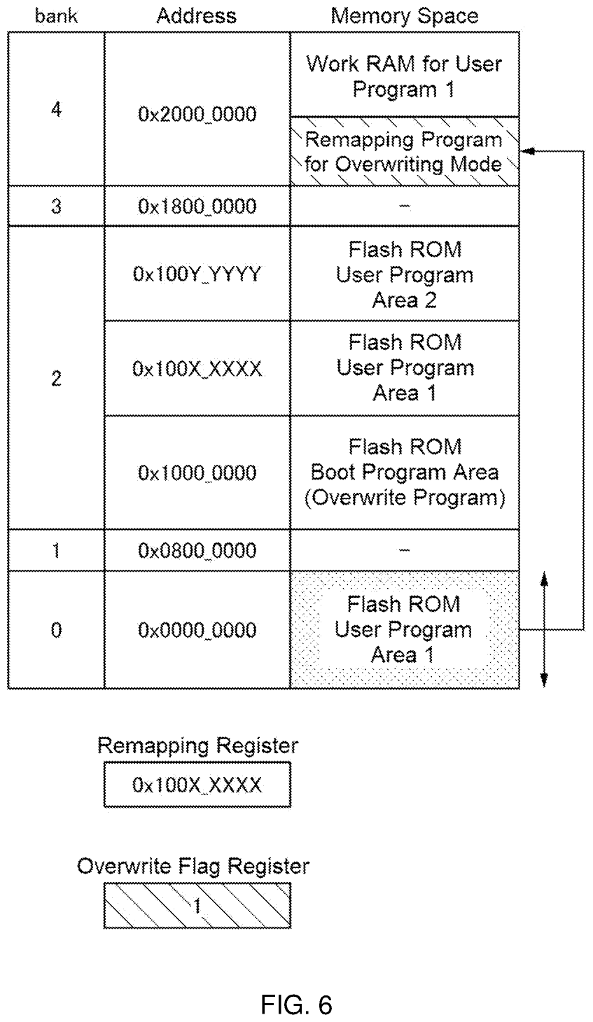

When the flag of the overwrite flag register is set to 1, then as shown in FIG. 6, the referent of the CPU jumps to the overwriting mode remapping program of the SRAM area of bank4. The reason for executing programs in a bank other than bank0 is to avoid a situation in which, if the CPU is executing a program in bank0 while bank0 is being remapped in the next step, the program is overwritten while being executed, causing the CPU to undergo a runaway process.

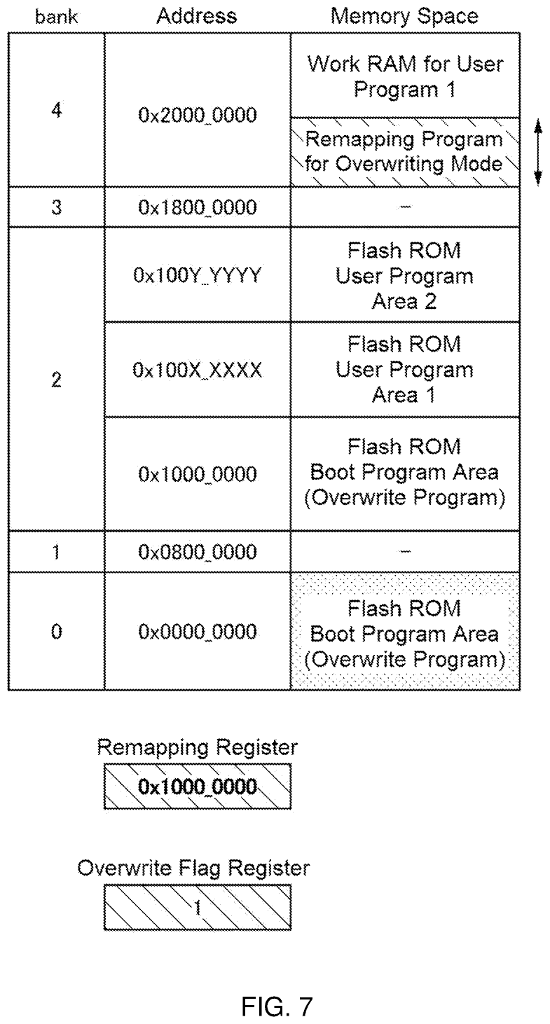

Next, as shown in FIG. 7, the CPU executes the overwriting mode remapping program of the SRAM area of bank4, remaps the flash ROM boot program area to bank0, and resets the CPU. When the overwrite flag register flag has a value of 1, the boot program is programmed so as to execute an overwrite program that overwrites the user program. Here, resetting the CPU refers to causing the CPU to execute programs in the memory space starting with bank0.

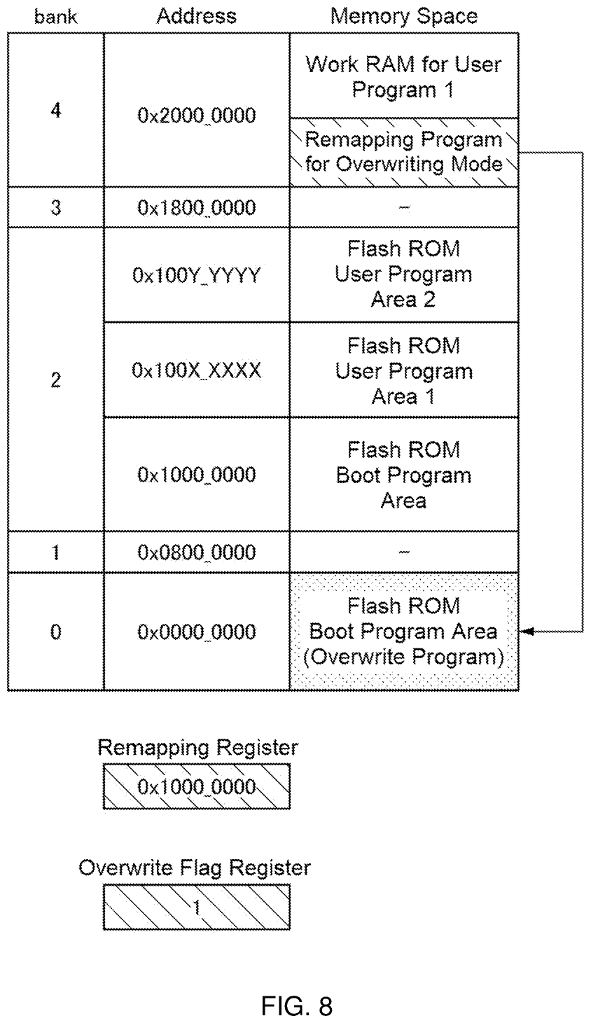

If the flash ROM boot program area is remapped to bank0 and the CPU is reset, then as shown in FIG. 8, the CPU executes programs starting with bank0. As described above, the program executed by the CPU here is the overwrite program for overwriting the user program. Here, an example is described in which a user program 2 starting at the address 0x100Y_YYYY is to be overwritten.

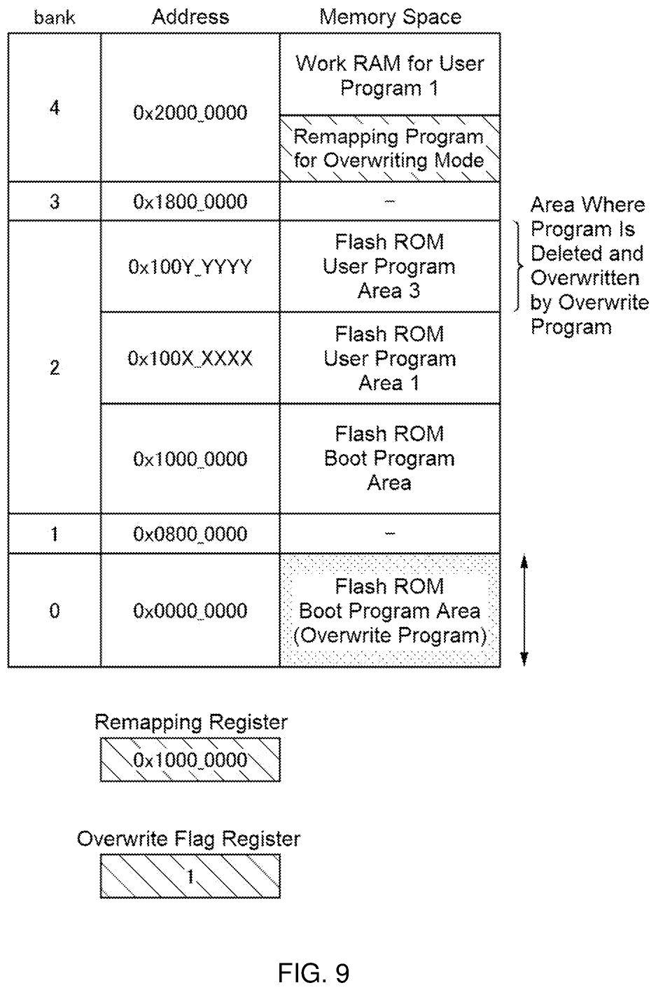

When the CPU executes the overwrite program, then as shown in FIG. 9, in the area starting with the address 0x100Y_YYYY, the user program 2 is overwritten with the user program 3.

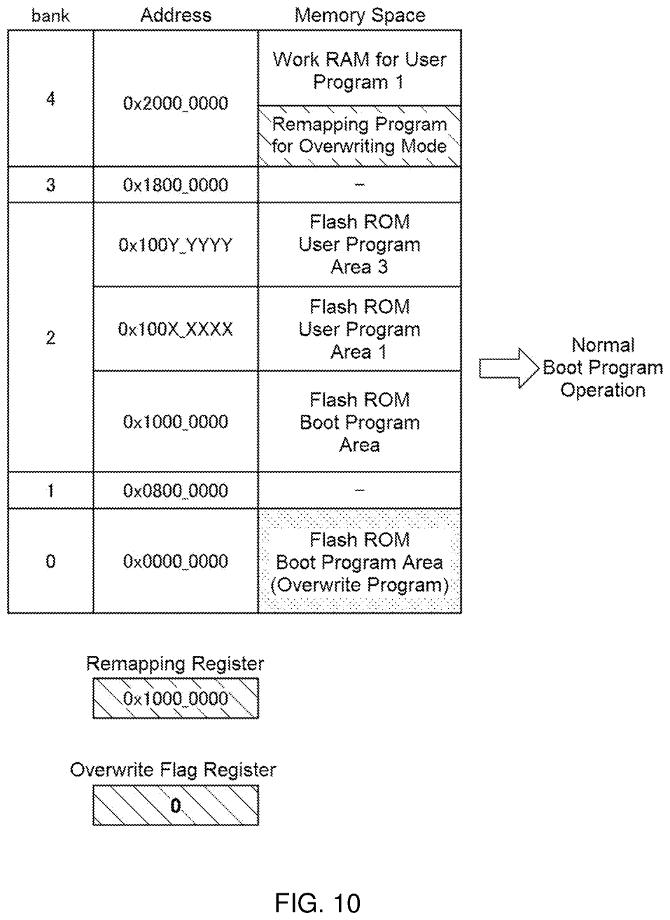

When overwriting is complete, then as shown in FIG. 10, the overwrite flag register flag is set to 0, and by executing a normal boot program operation, the MCU enters a state where the user program 3, with which the user program 2 was overwritten, is executable.

However, in this configuration, in order to update the user program, an overwriting mode remapping program needs to always be stored in a portion of the RAM area including the SRAM in order to update user programs. This presents the problem that the area of the RAM usable as the working memory for the user program is reduced.

The MCU according to the present embodiment enables the overwriting of a flash ROM without storing an overwriting mode remapping program in a portion of the area of the RAM.

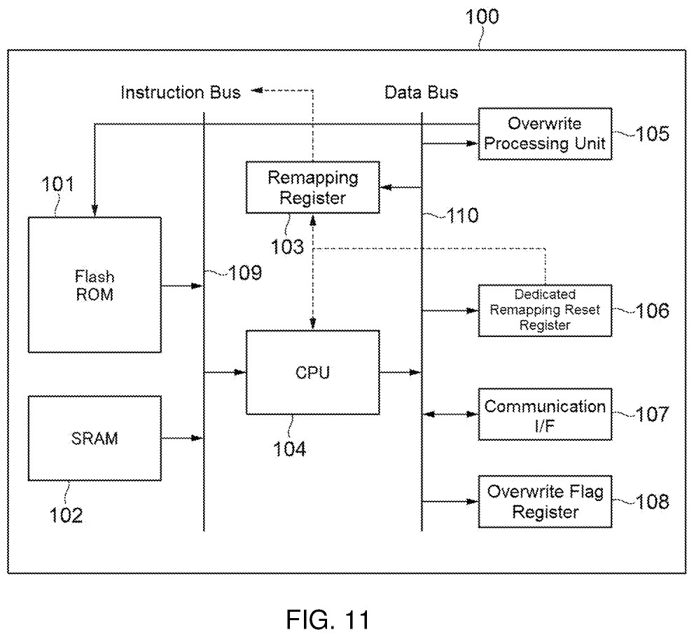

FIG. 11 shows a configuration example of an MCU 100 according to an embodiment of the present invention. As shown in FIG. 11, the MCU 100 includes a flash ROM 101, an SRAM 102, a remapping register 103, a CPU 104, an overwrite processing unit 105, a dedicated remapping reset register 106, a communication interface (I/F) 107, and an overwrite flag register 108. The flash ROM 101, the SRAM 102, and the CPU 104 are connected to an instruction bus 109. The remapping register 103, the CPU 104, the overwrite processing unit 105, the dedicated remapping reset register 106, the communication I/F 107, and the overwrite flag register 108 are connected to a data bus 110.

The flash ROM 101 is a rewritable non-volatile memory that stores programs that are read therefrom and executed by the CPU 104. The SRAM 102 is a volatile memory used as the working memory for a program when the CPU 104 executes the program. The flash ROM 101 and the SRAM 102 are examples of memory units of the present invention.

The remapping register 103 is an example of a remapping information storage area of the present invention, and is a register to which an address designating an area to be remapped to bank0 is written. The address of the remapping register 103 is written by the CPU 104 via the data bus 110. The CPU 104 is an example of a processor of the present invention, and reads and executes, via the instruction bus 109, programs stored in the flash ROM 101 and programs stored in the SRAM 102. When reading programs stored in the flash ROM 101, the CPU 104 reads programs remapped to bank0 on the basis of the address stored in the remapping register 103, for example.

The overwrite processing unit 105 is a processor that performs a process of overwriting programs in the flash ROM 101 if a flag for overwriting the flash ROM 101 is set in the overwrite flag register 108. The process of overwriting programs performed by the overwrite processing unit 105 is executed by the CPU 104 issuing an instruction to overwrite the program via the data bus 110. When performing the process to overwrite the program in the flash ROM 101, the overwrite processing unit 105 first deletes the program to be overwritten from the flash ROM 101, and then executes a process to write a new program to the flash ROM 101.

The dedicated remapping reset register 106 is an example of a reset information storage area of the present invention, and is a register to which information for performing a reset dedicated to remapping is written. Information for the dedicated remapping reset register 106 to perform a reset dedicated to remapping is written by the CPU 104 via the data bus 110. By writing a flag of 1 to the dedicated remapping reset register 106, for example, the reset dedicated to remapping is performed. The reset dedicated to remapping refers to resetting the remapping register 103 and the CPU 104 while not resetting the overwrite flag register 108. The dedicated remapping reset register 106 may be constituted of a 1-bit flip-flop, for example. Here, resetting the remapping register 103 refers to overwriting the address stored in the remapping register, and resetting the CPU 104 refers to causing the CPU to execute programs in the memory space starting with bank0. Also, resetting the overwrite flag register refers to overwriting the flag of the overwrite flag register.

The communication I/F 107 communicates with units outside of the MCU 100. For example, the communication I/F 107 receives, from outside of the MCU 100, the overwrite program stored in the flash ROM 101, overwrite instructions for programs in the flash ROM 101, and the like. As a result of the CPU 104 reading, via the data bus 110, programs and instructions received by the communication I/F 107, the CPU 104 recognizes that an overwrite instruction for a program was transmitted from outside.

The overwrite flag register 108 is an example of an overwrite flag storage area of the present invention, and is a register in which a flag for determining whether or not to overwrite a program in the flash ROM 101 is stored. The flag of the overwrite flag register 108 is stored by the CPU 104 via the data bus 110. For example, a flag indicating 1 is stored in the overwrite flag register 108 when overwriting is to be performed, and a flag indicating 0 is stored when overwriting is not to be performed.

By having the above configuration, the MCU 100 according to the embodiment of the present invention can update programs stored in the flash ROM 101 without storing, in the SRAM area, a program for resetting the remapping register 103 and the CPU 104.

Next, the operation of the MCU 100 will be described.

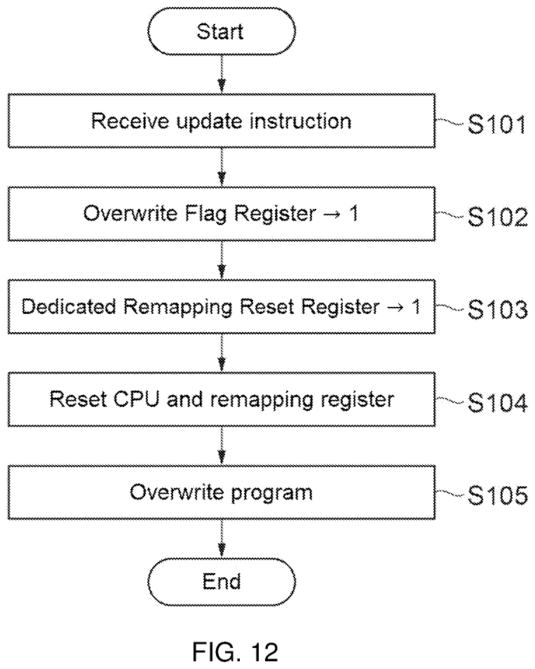

FIG. 12 is a flowchart showing an example of a reset process flow of the MCU 100 for a case in which an instruction to overwrite a program is received from outside. The CPU 104 reads the program from the flash ROM 101, loads the program to the SRAM 102, and executes the program, thereby causing the resetting process by the MCU 100 to be performed.

In step S101, when an overwriting instruction for a program and the actual program with which the original program is to be overwritten are transmitted from outside, the CPU 104 writes a flag for overwriting to the overwrite flag register 108 in the following step S102. Here, 1 is written to the overwrite flag register 108 as the flag for overwriting.

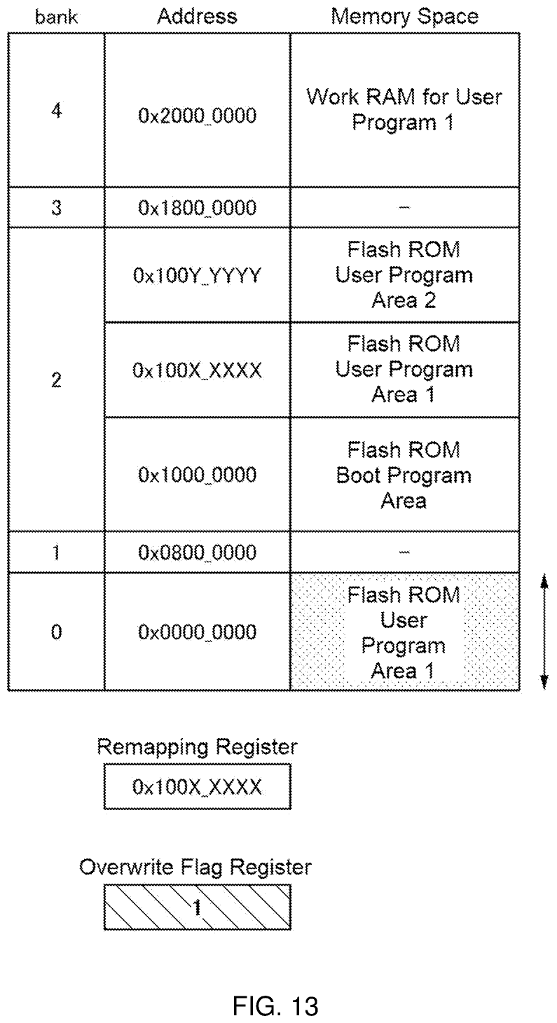

FIG. 13 is a drawing for describing one example of an overwriting flow for a user program stored in the flash ROM 101 of the MCU 100 according to the present embodiment, and describes the state in which a flag of 1 is written to the overwrite flag register 108 by the CPU 104 in a state where the address 0x100X_XXXX is written to the remapping register 103. Similarly to FIG. 1, FIG. 13 shows addresses and memory spaces corresponding to “bank,” which indicates the subdivisions of the memory space.

In the next step S103, the CPU 104 writes information for performing a reset dedicated to remapping to the dedicated remapping reset register 106. Here, a flag of 1 for performing a reset dedicated to remapping is written to the dedicated remapping reset register 106.

When 1 is written as the flag to the dedicated remapping reset register 106, the MCU 100 resets the CPU 104 and the remapping register 103 in the next step S104. Because 1 is written as a flag to the overwrite flag register 108, the MCU 100 executes overwriting of the program written to the flash ROM 101 in the next step S105.

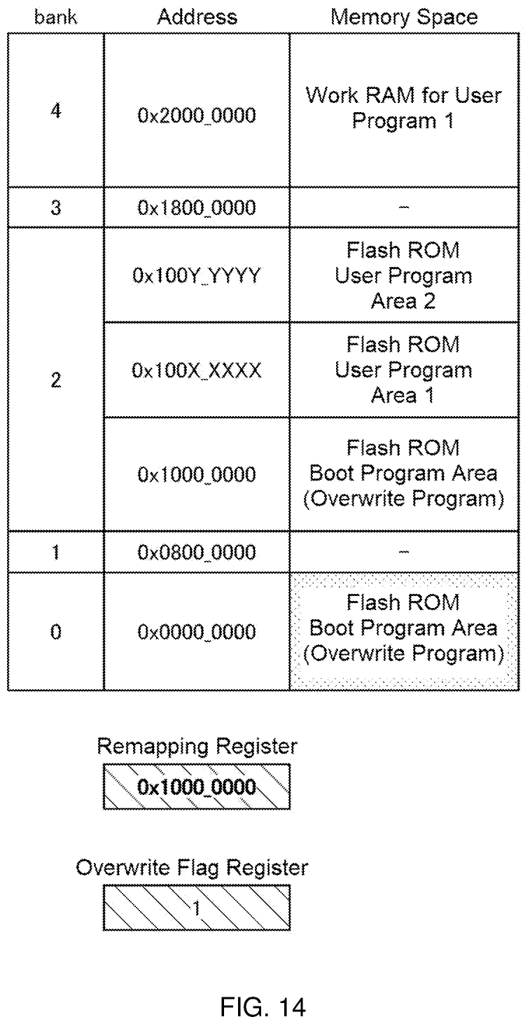

FIG. 14 is a drawing for describing one example of an overwriting flow for a user program stored in the flash ROM 101 of the MCU 100 according to the present embodiment, and describes the state in which the MCU 100 has reset the CPU 104 and the remapping register 103. Similarly to FIG. 1, FIG. 14 shows addresses and memory spaces corresponding to “bank,” which indicates the subdivisions of the memory space. The remapping register 103 has been reset, and thus, the address 0x1000_0000 is written to the remapping register 103, and the CPU 104 remaps the area starting with the address 0x1000_0000 to bank0. The CPU 104 has been reset, and thus, the CPU 104 starts by executing the program in bank0. Also, the overwrite flag register 108 has not been reset, and thus, the state in which 1 is written as the flag continues. Thus, because the flag of the overwrite flag register 108 has a value of 1, the CPU 104 instructs the overwrite processing unit 105 to overwrite the program, and the overwrite processing unit 105 overwrites the program written to the flash ROM 101.

By the above process, the MCU 100 according to the embodiment of the present invention can update programs stored in the flash ROM 101 without storing, in the SRAM area, a program for resetting the remapping register 103 and the CPU 104, similar to those described in the comparison example. Thus, it is possible to mitigate a reduction in the usable capacity of a memory, while enabling updating of programs stored in the memory.

Also, as a result of the MCU 100 according to embodiment of the present invention executing the above process, it is possible to update programs stored in the flash ROM 101, without jumping to a bank aside from the bank0 and executing the overwriting mode remapping program in the manner described in the comparison example. Thus, it is possible to reduce the time necessary to update programs.

In each of the embodiments above, an aspect was described in which the program for the resetting process is installed in advance in the flash ROM, but the configuration is not limited thereto. The program may be stored in a non-transitory storage medium such as a CD-ROM (compact disc read-only memory), a DVD-ROM (digital versatile disc read-only memory), or a USB (universal serial bus) memory. Alternatively, the program may be downloadable from an external device via a network.

Above, embodiments of the present invention were described in detail with reference to the affixed drawings, but the technical scope of the present invention is not limited to the examples. It is obvious that a person with typical knowledge in the technical field of the present invention could conceive of various modifications or revisions within the scope of the technical concept disclosed in the claims, and any of the various modifications and revisions are naturally understood to belong to the technical scope of the present invention.

What is claimed is:

1. A microcontroller, comprising:
a memory unit;
a processor that reads a program stored in the memory unit from the memory unit and executes a process;
a remapping information storage area that stores an address that designates an area to be remapped by the processor;
an overwrite flag storage area that stores a flag that determines whether or not to overwrite the program stored in the memory unit; and
a reset information storage area to store information for resetting the processor and the remapping information storage area when information indicating resetting of the processor and the remapping information storage area is written to the reset information storage area.

2. The microcontroller according to claim 1,
wherein, when the information indicating resetting of the processor and the remapping information storage area is written to the reset information storage area and the processor and the remapping information storage area are reset, the overwrite flag storage area is not reset.

3. The microcontroller according to claim 1,
wherein the reset information storage area is a 1-bit flip-flop.

4. The microcontroller according to claim 1,
wherein a program that performs overwriting of the program stored in the memory unit is stored at a location outside of the memory unit.

5. An update method for a microcontroller, comprising:
a reset information writing step of writing, to a reset information storage area, information indicating resetting of a processor that executes a process by reading a program stored in a memory unit from the memory unit, and a remapping information storage area that stores an address that designates an area to be remapped by the processor; and
a dedicated remapping reset step of resetting the processor and the remapping information storage area based on the information written to the reset information storage area.

6. The update method for a microcontroller according to claim 5,
wherein, in the dedicated remapping reset step, an overwrite flag storage area that stores a flag that determines whether or not to overwrite the program stored in the memory unit is not reset when the processor is reset.

7. The update method for a microcontroller according to claim 5, further comprising:
an overwrite flag writing step of writing a flag indicating overwriting of the program in the overwrite flag storage area when an instruction to overwrite the program stored in the memory unit is transmitted from outside; and
a program overwriting step of overwriting the program stored in the memory unit after the dedicated remapping reset step.
